(19) United States
(12) Patent Application Publication
(10) Pub. No.: US 2009/0021016 A1
(43) Pub. Date: Jan. 22, 2009

(54) Double gravity/buoyancy/density energy process

(76) Inventor: Troy Edward McDermott, Minooka, IL (US)

Correspondence Address: Troy McDermott, 629 Chestnut Ridge Dr., Monooka, IL, 60447, US

(21) Appl. No.: 11/879,903

(22) Filed: Jul. 20, 2007

(51) Int. Cl. F03B 13/12; H02K 53/00

(52) U.S. Cl. 290/53; 74/DIG. 9

(57) ABSTRACT

The process using gravity/buoyancy/density twice (sinking and rising) to produce electrical or mechanical energy through displaced volume is new. The fact that gravity is a constant force, not variable like solar or wind energy, makes this process continuous in the production of electrical or mechanical energy. The fact that gravity is free is also an asset allowing for just construction and maintenance costs. In addition, the process does not pollute. Many designs using this process are viable for large and small scale facilities.

### CROSS REFERENCE TO RELATED APPLICATIONS

Not applicable

### STATEMENT REGARDING FEDERALLY SPONSORED RESEARCH OR DEVELOPMENT

Not applicable

### REFERENCE TO A SEQUENCE LISTING

Not applicable

### BACKGROUND OF THE INVENTION

This invention pertains to the field of physics and science in relation to energy production.

### BRIEF SUMMARY OF THE INVENTION

The process uses gravity/buoyancy/density twice to produce electrical or mechanical energy through the creation of a displaced volume in an object which is weighted to sink and then rise in a body of water/matter.

### BRIEF DESCRIPTION OF THE SEVERAL VIEWS OF THE DRAWING

Not applicable

### DETAILED DESCRIPTION OF THE INVENTION

The process uses gravity twice to produce electrical or mechanical energy involving sinking a weight (vessel/container) through water/matter through a distance. The weight is attached to a mechanism (i.e. pulleys, gears, wires, etc.) which turns a drive shaft or device to transfer energy to electrical or mechanical energy. When the sinking weight (vessel/container) has reached a specific depth in water/matter an exchange of volume happens. Water/matter is exchanged for air/matter giving the weight {vessel/container} buoyancy. This exchange can happen at rest (held in place) or while in motion. The exchange can be achieved through the following methods, but not limited to:
1) draining water into an open environment
2) by counterweights (static equilibrium requiring minimum force to move a vessel/container creating a displaced volume for an exchange between water/matter and air/matter)
   a. At the bottom of a body of water an enclosure rises to equal the amount of volume displaced and it is then closed off. Initially, the enclosure is open to the environment above the body of water/matter.
3) pumps
4) compressors forcing matter out
5) other mechanical or electrical devices
6) chemical reactions
7) any combinations of the methods
   The weight now has a buoyant force which sends the weight to the surface of the water/matter. Still attached to the same system during the descent, the ascent can also be used for the production of electrical or mechanical energy.

1. The process using gravity/buoyancy/density twice (sinking and rising) to produce electrical or mechanical energy through use of displaced volume.

2. The process of creating displaced volume through the use of counterweights.

3. Exchanging matter by allowing matter to drain into open environment with the less dense medium (gas state) rising to replace denser medium (liquid state) during the Double Gravity/Buoyancy/Density Energy Process.
